(19) United States
(12) Patent Application Publication
(10) Pub. No.: US 2003/0135718 A1
(43) Pub. Date: Jul. 17, 2003

(54) Method and system using hardware assistance for instruction tracing by revealing executed opcode or instruction

(75) Inventors: Jimmie Earl DeWitt JR., Georgetown, TX (US); Riaz Y. Hussain, Austin, TX (US); Frank Eliot Levine, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 10/045,124

(22) Filed: Jan. 14, 2002

(51) Int. Cl. G06F 15/00

(52) U.S. Cl. 712/227

(57) ABSTRACT

A method, system, apparatus, and computer program product is presented for assisting instruction tracing operations. A mechanism is provided within the processor for revealing the most recently executed instruction. After the instruction is completed, the opcode of the instruction or the entire instruction is revealed in one of a variety of manners, such as by writing the opcode or instruction to a register that may be read by application-level code. Alternatively, a series of instructions may be stored in a trace buffer within the processor upon the completion of each instruction. In another alternative, the size and address of a trace buffer in memory may be placed into configuration registers, and a series of instructions may be stored in the trace buffer after the completion of each instruction. The tracing operation for the series of instructions may be qualified so that it is performed only in a taken-branch tracing mode.

### CROSS-REFERENCE TO RELATED APPLICATION

The present application is related to the following application: application Ser. No. ______ (Attorney Docket Number AUS920010717US1), filed (TBD), titled “Method and system using hardware assistance for tracing instruction disposition information”.

### BACKGROUND OF THE INVENTION

1. Field of the Invention

The present invention relates generally to an improved data processing system and, in particular, to a method and system for instruction processing within a processor in a data processing system.

2. Description of Related Art

In analyzing the performance of a data processing system and/or the applications executing within the data processing system, it is helpful to understand the execution flows and the use of system resources. Performance tools are used to monitor and examine a data processing system to determine resource consumption as various software applications are executing within the data processing system. For example, a performance tool may identify the most frequently executed modules and instructions in a data processing system, or it may identify those modules which allocate the largest amount of memory or perform the most I/O requests. Hardware performance tools may be built into the system or added at a later point in time. Software performance tools also are useful in data processing systems, such as personal computer systems, which typically do not contain many, if any, built-in hardware performance tools.

One known software performance tool is a trace tool. A trace tool may use more than one technique to provide trace information that indicates execution flows for an executing program. For example, a trace tool may log every entry into, and every exit from, a module, subroutine, method, function, or system component. Alternately, a trace tool may log the amounts of memory allocated for each memory allocation request and the identity of the requesting thread. Typically, a time-stamped record is produced for each such event. Corresponding pairs of records similar to entry-exit records also are used to trace execution of arbitrary code segments, starting and completing I/O or data transmission, and for many other events of interest.

In order to improve software performance, it is often necessary to determine where time is being spent by the processor in executing code, such efforts being commonly known in the computer processing arts as locating “hot spots.” Within these hot spots, there may be lines of code that are frequently executed. When there is a point in the code where one of two or more branches may be taken, it is useful to know which branch is the mainline path, or the branch most frequently taken, and which branch or branches are the exception branches. Grouping the instructions in the mainline branches of the module closely together also increases the likelihood of cache hits because the mainline code is the code that will most likely be loaded into the instruction cache.

Ideally, one would like to isolate such hot spots at the instruction level and/or source line level in order to focus attention on areas which might benefit most from improvements to the code. For example, isolating such hot spots to the instruction level permits a compiler developer to find significant areas of suboptimal code generation. Another potential use of instruction level detail is to provide guidance to CPU developers in order to find characteristic instruction sequences that should be optimized on a given type of processor.

Another analytical methodology is instruction tracing by which an attempt is made to log every executed instruction. Instruction tracing is an important analytical tool for discovering the lowest level of behavior of a portion of software.

However, implementing an instruction tracing methodology is a difficult task to perform reliably because the tracing program itself causes some interrupts to occur. If the tracing program is monitoring interrupts and generating trace output records for those interrupts, then the tracing program may log interrupts that it has caused through its own operations. In that case, it would be more difficult for a system analyst to interpret the trace output during a post-processing phase because the information for the interrupts caused by the tracing program should first be recognized and then should be filtered or ignored when recognized.

More specifically, instruction tracing may cause interrupts while trying to record trace information because the act of accessing an instruction may cause interrupts, thereby causing unwanted effects at the time of the interrupt and generating unwanted trace output information. A prior art instruction tracing technique records information about the next instruction that is about to be executed. In order to merely log the instruction before it is executed, several interrupts can be generated with older processor architectures, such as the X86 family, while simply trying to access the instruction before it is executed. For example, an instruction cache miss may be generated because the instruction has not yet been fetched into the instruction cache, and if the instruction straddles a cache line boundary, another instruction cache miss would be generated. Similarly, there could be one or two data cache misses for the instruction's operands, each of which could also trigger a page fault.

In order to accurately reflect the system flow, the tracing software should not trace its own instructions or the effects of its execution. However, if the tracing software generates interrupts, exceptions, etc., it may be difficult to determine whether the interrupts would occur normally by the software without tracing or if the interrupt is only caused by the act of tracing. For example, if the tracing code is also tracing data accesses, which have not yet occurred, any page faults associated with the access of the data would be generated not only by the act of tracing but also would have occurred when the instruction itself was executed. In this case, if the tracing software suppresses tracing of the exception, the information regarding the exception would be lost. If the tracing software is attempting to copy an instruction that has not yet been executed, interrupts associated with the act of copying should not be recorded. If the tracing software reads the actual instruction and the instruction passes a page boundary, then normal execution path would cause a page fault, which should be recorded. If the tracing software reads more bytes than is required to execute the instruction and the read operation passes a page boundary, then the normal execution path may or may not pass a page boundary.

Therefore, it would be advantageous to have hardware structures within the processor that assist in the identification of executed instructions in order to minimize unwanted interrupts within the system that is being analyzed.

### SUMMARY OF THE INVENTION

A method, system, apparatus, and computer program product is presented for assisting instruction tracing operations. A mechanism is provided within the processor for revealing the most recently executed instruction. After the instruction is completed, the opcode of the instruction or the entire instruction is revealed in one of a variety of manners, such as by writing the opcode or instruction to a register that may be read by application-level code. Alternatively, a series of instructions may be stored in a trace buffer within the processor upon the completion of each instruction. In another alternative, the size and address of a trace buffer in memory may be placed into configuration registers, and a series of instructions may be stored in the trace buffer after the completion of each instruction. The tracing operation for the series of instructions may be qualified so that it is performed only in a taken-branch tracing mode.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical data processing system in which the present invention may be implemented;

FIG. 1B depicts typical structures in a processor and a memory subsystem in which the present invention may be implemented;

FIG. 1C depicts typical software components within a computer system illustrating a logical relationship between the components as functional layers of software;

FIG. 1D depicts a typical relationship between software components in a data processing system that is being analyzed in some manner by a trace facility;

FIG. 1E depicts typical phases that may be used to characterize the operation of a tracing facility;

FIG. 2A depicts an executed-instruction register within a processor that may be used to reveal an executed instruction;

FIG. 2B depicts an executed-instruction register within a processor that is protected by an executed-instruction (EI) control flag;

FIG. 2C depicts a flowchart for the use of a EI control flag associated with an executed-instruction register within a processor;

FIG. 2D depicts an executed-instruction register that is protected by an EI flag to be used in conjunction with other control flags, such as interrupt control flags;

FIG. 3A depicts a taken-branch instruction buffer to be used to store executed instructions with respect to the most recent branch-type instruction;

FIG. 3B depicts a flowchart for the use of a taken-branch instruction buffer within a processor; and

FIG. 4 depicts an alternative embodiment for a taken-branch instruction buffer to be used to store executed instructions.

### DETAILED DESCRIPTION OF THE INVENTION

The present invention is directed to hardware structures within a processor that assist in the identification of completed instructions during tracing operations. As background, a typical organization of hardware and software components within a data processing system is described prior to describing the present invention in more detail.

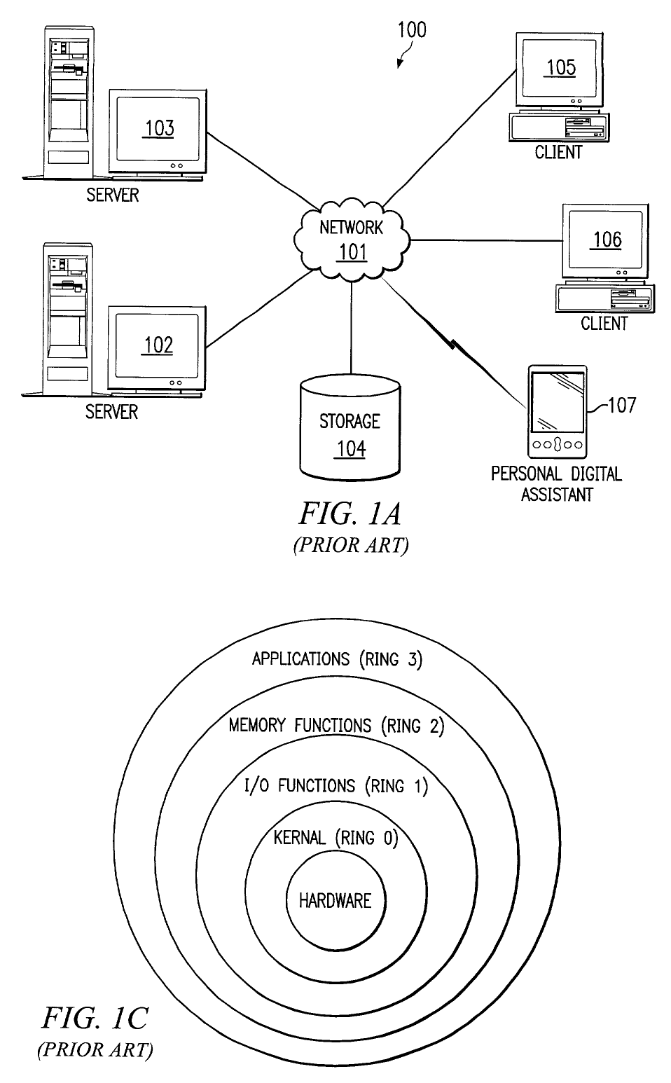

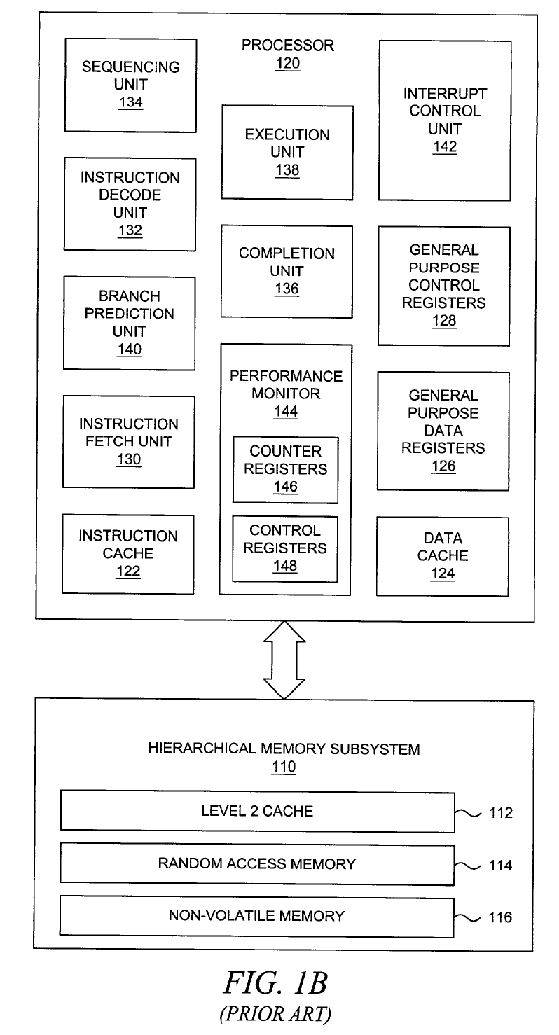

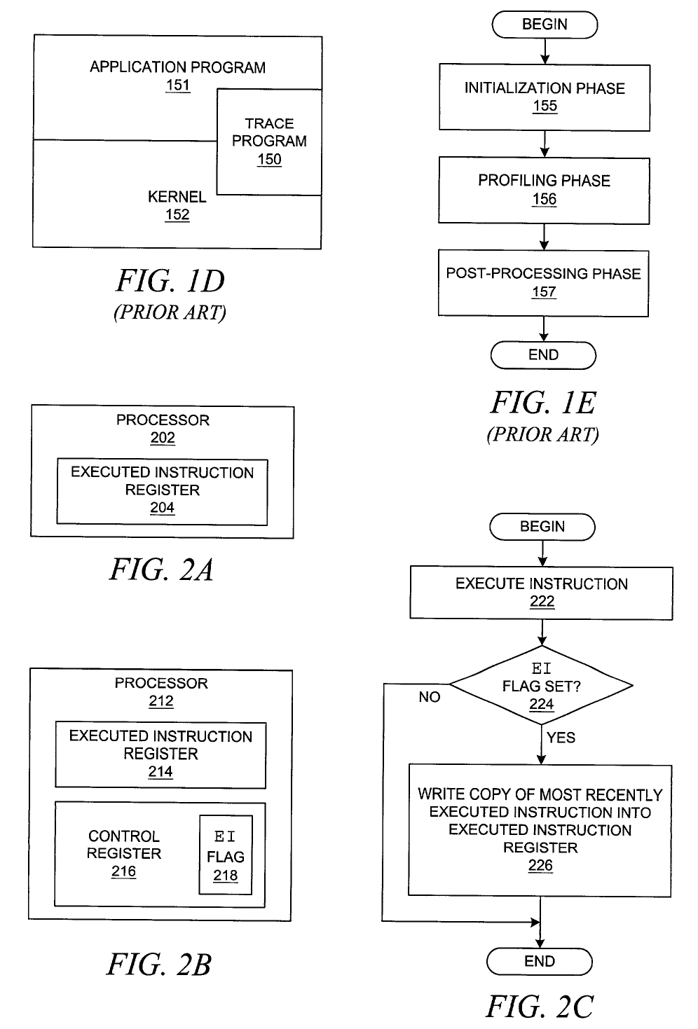

With reference now to the figures, FIG. 1A depicts a typical data processing system in which the present invention may be implemented. Data processing system 100 contains network 101, which is the medium used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 may be a variety of computing devices, such as personal computers, personal digital assistants (PDAs), etc. Distributed data processing system 100 may include additional servers, clients, and other devices not shown. In the depicted example, distributed data processing system 100 may include the Internet with network 101 representing a worldwide collection of networks and gateways that use the TCP/IP suite of protocols to communicate with one another. Of course, distributed data processing system 100 may also be configured to include a number of different types of networks, such as, for example, an intranet, a local area network (LAN), or a wide area network (WAN).

FIG. 1A is intended as an example of a heterogeneous computing environment and not as an architectural limitation for the present invention. The present invention could be implemented on a variety of hardware platforms, such as server 102 or client 107 shown in FIG. 1A. Requests for the collection of performance information may be initiated on a first device within the network, while a second device within the network receives the request, collects the performance information for applications executing on the second device, and returns the collected data to the first device.

With reference now to FIG. 1B, a block diagram depicts typical structures in a processor and a memory subsystem that may be used within a client or server, such as those shown in FIG. 1A, in which the present invention may be implemented. Hierarchical memory 110 comprises Level 2 cache 112, random access memory (RAM) 114, and non-volatile memory 116. Level 2 cache 112 provides a fast access cache to data and instructions that may be stored in RAM 114 in a manner which is well-known in the art. RAM 114 provides main memory storage for data and instructions that may also provide a cache for data and instructions stored in nonvolatile memory 116, such as a flash memory or a disk drive.

Processor 120 comprises a pipelined processor capable of executing multiple instructions in a single cycle. During operation of the data processing system, instructions and data are stored in hierarchical memory 110. Data and instructions may be transferred to processor 120 from hierarchical memory 110 on a common data path/bus or on independent data paths/buses. In either case, processor 120 may provide separate instruction and data transfer paths within processor 120 in conjunction with instruction cache 122 and data cache 124. Instruction cache 122 contains instructions that have been cached for execution within the processor. Some instructions may transfer data to or from hierarchical memory 110 via data cache 124. Other instructions may operate on data that has already been loaded into general purpose data registers 126, while other instructions may perform a control operation with respect to general purpose control registers 128.

Fetch unit 130 retrieves instructions from instruction cache 122 as necessary, which in turn retrieves instructions from memory 110 as necessary. Decode unit 132 decodes instructions to determine basic information about the instruction, such as instruction type, source registers, and destination registers.

In this example, processor 120 is depicted as an out-of-order execution processor. Sequencing unit 134 uses the decoded information to schedule instructions for execution. In order to track instructions, completion unit 136 may have data and control structures for storing and retrieving information about scheduled instructions. As the instructions are executed by execution unit 138, information concerning the executing and executed instructions is collected by completion unit 136. Execution unit 138 may use multiple execution subunits. As instructions complete, completion unit 136 commits the results of the execution of the instructions; the destination registers of the instructions are made available for use by subsequent instructions, or the values in the destination registers are indicated as valid through the use of various control flags. Subsequent instructions may be issued to the appropriate execution subunit as soon as its source data is available.

In this example, processor 120 is also depicted as a speculative execution processor. Generally, instructions are fetched and completed sequentially until a branch-type instruction alters the instruction flow, either conditionally or unconditionally. After decode unit 132 recognizes a conditional branch operation, sequencing unit 134 may recognize that the data upon which the condition is based is not yet available; e.g., the instruction that will produce the necessary data has not been executed. In this case, fetch unit 130 may use one or more branch prediction mechanisms in branch prediction unit 140 to predict the outcome of the condition. Control is then speculatively altered until the results of the condition can be determined. Depending on the capabilities of the processor, multiple prediction paths may be followed, and unnecessary branches are flushed from the execution pipeline.

Since speculative instructions can not complete until the branch condition is resolved, many high performance out-of-order processors provide a mechanism to map physical registers to virtual registers. The result of execution is written to the virtual register when the instruction has finished executing. Physical registers are not updated until an instruction actually completes. Any instructions dependent upon the results of a previous instruction may begin execution as soon as the virtual register is written. In this way, a long stream of speculative instructions can be executed before determining the outcome of a conditional branch.

Interrupt control unit 142 controls events that occur during instruction processing that cause execution flow control to be passed to an interrupt handling routine. A certain amount of the processor's state at the time of the interrupt is saved automatically by the processor. After completion of interruption processing, a return-from-interrupt (RFI) can be executed to restore the saved processor state, at which time the processor can proceed with the execution of the interrupted instruction. Interrupt control unit 142 may comprise various data registers and control registers that assist the processing of an interrupt.

Certain events occur within the processor as instructions are executed, such as cache accesses or Translation Lookaside Buffer (TLB) misses. Performance monitor 144 monitors those events and accumulates counts of events that occur as the result of processing instructions. Performance monitor 144 is a software-accessible mechanism intended to provide information concerning instruction execution and data storage; its counter registers and control registers can be read or written under software control via special instructions for that purpose. Performance monitor 144 contains a plurality of performance monitor counters (PMCs) or counter registers 146 that count events under the control of one or more control registers 148. The control registers are typically partitioned into bit fields that allow for event/signal selection and accumulation. Selection of an allowable combination of events causes the counters to operate concurrently; the performance monitor may be used as a mechanism to monitor the performance of the stages of the instruction pipeline.

Those of ordinary skill in the art will appreciate that the hardware in FIG. 1B may vary depending on the system implementation. The depicted example is not meant to imply architectural limitations with respect to the present invention.

With reference now to FIG. 1C, a prior art diagram shows software components within a computer system illustrating a logical relationship between the components as functional layers of software. The kernel (Ring 0) of the operating system provides a core set of functions that acts as an interface to the hardware. I/O functions and drivers can be viewed as resident in Ring 1, while memory management and memory-related functions are resident in Ring 2. User applications and other programs (Ring 3) access the functions in the other layers to perform general data processing. Rings 0-2, as a whole, may be viewed as the operating system of a particular device. Assuming that the operating system is extensible, software drivers may be added to the operating system to support various additional functions required by user applications, such as device drivers for support of new devices added to the system.

In addition to being able to be implemented on a variety of hardware platforms, the present invention may be implemented in a variety of software environments. A typical operating system may be used to control program execution within each data processing system. For example, one device may run a Linux® operating system, while another device may run an AIX® operating system.

With reference now to FIG. 1D, a simple block diagram depicts a typical relationship between software components in a data processing system that is being analyzed in some manner by a trace facility. Trace program 150 is used to analyze application program 151. Trace program 150 may be configured to handle a subset of interrupts on the data processing system that is being analyzed. When an interrupt or trap occurs, e.g., a single-step trap or a taken-branch trap, functionality within trace program 150 can perform various tracing functions, profiling functions, or debugging functions; hereinafter, the terms tracing, profiling, and debugging are used interchangeably. In addition, trace program 150 may be used to record data upon the execution of a hook, which is a specialized piece of code at a specific location in an application process. Trace hooks are typically inserted for the purpose of debugging, performance analysis, or enhancing functionality. Typically, trace program 150 generates trace data of various types of information, which is stored in a trace data buffer and subsequently written to a data file for post-processing.

Both trace program 150 and application program 151 use kernel 152, which comprises and/or supports system-level calls, utilities, and device drivers. Depending on the implementation, trace program 150 may have some modules that run at an application-level priority and other modules that run at a trusted, system-level priority with various system-level privileges.

It should be noted that the instruction tracing functionality of the present invention may be placed in a variety of contexts, including a kernel, a kernel driver, an operating system module, or a tracing process or program. Hereinafter, the term “tracing program” or “tracing software” is used to simplify the distinction versus typical kernel functionality and the processes generated by an application program. In other words, the executable code of the tracing program may be placed into various types of processes, including interrupt handlers.

In addition, it should be noted that hereinafter the term “current instruction address” or “next instruction” refers to an instruction within an application that is being profiled/traced and does not refer to the next instruction within the profiling/tracing program. When a reference is made to the value of the instruction pointer, it is assumed that the processor and/or operating system has saved the instruction pointer that was being used during the execution of the application program; the instruction pointer would be saved into a special register or stack frame, and this saved value is retrievable by the tracing program. Hence, when an instruction pointer is discussed herein, one refers to the value of the instruction pointer for the application program at the point in time at which the application program was interrupted.

With reference now to FIG. 1E, a diagram depicts typical phases that may be used to characterize the operation of a tracing facility. An initialization phase 155 is used to capture the state of the client machine at the time tracing is initiated. This trace initialization data may include trace records that identify all existing threads, all loaded classes, and all methods for the loaded classes; subsequently generated trace data may indicate thread switches, interrupts, and loading and unloading of classes and jitted methods. A special record may be written to indicate within the trace output when all of the startup information has been written.

Next, during the profiling phase 156, trace records are written to a trace buffer or file. Subject to memory constraints, the generated trace output may be as long and as detailed as an analyst requires for the purpose of profiling or debugging a particular program.

In the post-processing phase 157, the data collected in the buffer is sent to a file for post-processing. During post-processing phase 158, each trace record is processed in accordance with the type of information within the trace record. After all of the trace records are processed, the information is typically formatted for output in the form of a report. The trace output may be sent to a server, which analyzes the trace output from processes on a client. Of course, depending on available resources or other considerations, the post-processing also may be performed on the client. Alternatively, trace information may be processed on-the-fly so that trace data structures are maintained during the profiling phase.

As mentioned previously, instruction tracing is an important analysis tool, but instruction tracing is difficult to perform reliably because the act of accessing an instruction to be traced may cause interrupts, thereby causing unwanted effects at the time of the interrupt and generating unwanted trace output information.

This type of effect is particularly troublesome to a tracing program that has instruction tracing functionality. At some point in time, the tracing program is given execution control, typically through a single-step or trap-on-branch interrupt. At that point in time, the processor's instruction pointer indicates the next instruction to be executed; the instruction pointer points to the address of the next instruction.

In some cases, the processor may prefetch instructions into an instruction cache. Hence, at the point in time that the single-step or trap-on-branch interrupt occurs, the processor may have a copy of the instruction in a unit within the processor, such as instruction cache 122 or instruction decode unit 132 in FIG. 1B. Unlike some internal structures in a performance monitor, certain internal structures within the processor are only accessible to the microcode or nanocode within the processor, and these internal structures are not accessible to application-level code. In other words, there are no processor instructions that can be used by the tracing program to read the processor's copy of the instruction if the processor already has a copy.

In order to perform an instruction tracing operation, the tracing program typically attempts to read the current instruction by using the address that is indicated by the instruction pointer; the instruction pointer points to a location within main memory. However, if the instruction is contained within an execute-only memory block, the attempted access of the instruction by the tracing program causes some type of error signal for which the tracing program should compensate. In other cases, several interrupts can be generated while simply trying to access the instruction if the instruction has not yet been fetched, e.g., interrupts associated with page faults or a TLB miss.

Hence, it would be advantageous to provide hardware assistance within a processor in order to capture copies of executed instructions for tracing purposes. The present invention is described in more detail further below with respect to the remaining figures.

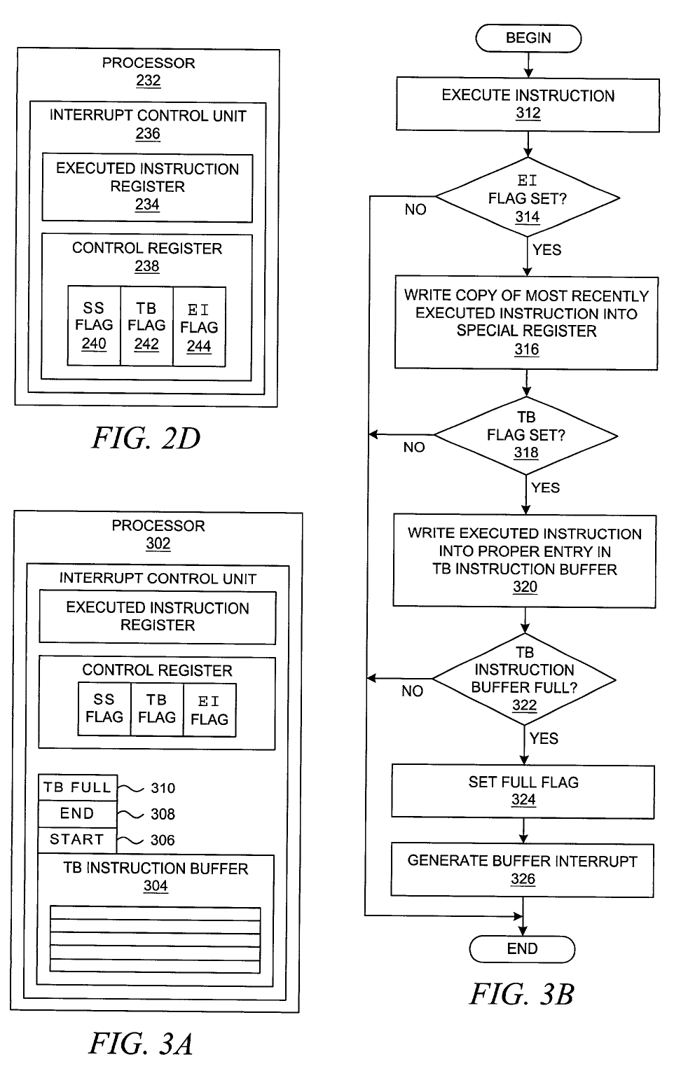

With reference now to FIG. 2A, a block diagram depicts an executed-instruction register within a processor that may be used to reveal an executed instruction in accordance with the present invention. Processor 202, which is similar to processor 120 shown in FIG. 1B, is constructed to include a dedicated register, executed-instruction register 204, that contains a copy of the most recently executed instruction. Alternatively, executed-instruction register 204 contains a copy of the opcode of the most recently executed instruction. Executed-instruction register 204 may be physically placed within various units within processor 202 as appropriate; for example, executed-instruction register 204 may be contained within an execution unit, a completion unit, or a performance monitor. Executed-instruction register 204 may be restricted to read-only operations by application-level code as necessary.

It should also be noted that the executed-instruction register need not be a dedicated purpose register; the processor may deliver a copy of the most recently executed instruction to a general purpose register, a performance monitor register, or other register as may be requested or as may be appropriate for the implemented processor architecture. In any case, the executed instruction is made available in a processor structure so that a read operation may be performed to retrieve a copy of the most recently executed instruction.

With reference now to FIG. 2B, a block diagram depicts an executed-instruction register within a processor that is protected by an executed-instruction (EI) control flag. Processor 212 contains executed-instruction register 214 in a manner similar to FIG. 2A. In contrast with FIG. 2A, FIG. 2B also shows control register 216, which is typically used to enable features or to specify bit-wise parameters within the processor.

With respect to the present invention, control register 216 also contains executed-instruction (EI) flag 218, which is a software-specifiable flag that enables the feature of placing the most recently executed instruction into executed-instruction register 214. The executed-instruction flag may be useful for a variety of reasons. For example, the operation of revealing the most recently executed opcode or instruction may require additional processor time, such as an additional internal cycle, because the processor may have to perform additional work to collect the most recently executed instruction, e.g., obtaining the instruction from one of multiple execution subunits and then delivering it to the executed-instruction register. The executed-instruction flag may be set by a special purpose instruction or by a generalized instruction through which software can read and write control registers and/or status registers within the processor.

With reference now to FIG. 2C, a flowchart depicts the use of an EI control flag for an executed-instruction register within a processor. The process begins with the completion of the execution of an instruction (step 222), which may be signaled by a completion unit within the processor. A determination is then made as to whether the executed-instruction (EI) flag has been set (step 224). If the flag is set, then a copy of the executed instruction or its opcode is written to a register within the processor (step 226), e.g., a dedicated register that holds only executed instructions, such as executed-instruction register 214 shown in FIG. 2B, thereby completing the process.

The flowchart in FIG. 2C only shows the manner in which a value is written to the executed-instruction register. It is assumed that the executed-instruction register is read when the executed-instruction or opcode is needed, such as by an instruction tracing routine that writes the executed instruction or opcode to a trace output buffer.

With reference now to FIG. 2D, a block diagram depicts an executed-instruction register that is protected by an EI flag to be used in conjunction with other control flags, such as interrupt control flags. Processor 232 contains executed-instruction register 234 in a manner similar to FIG. 2B. In contrast with FIG. 2B, FIG. 2D shows executed-instruction register 234 as being located within interrupt control unit 236 that contains control register 238 for controlling the operation of the interrupt control unit. Instruction-level tracing is typically accomplished in conjunction with interrupt processing.

A tracing program may set single-step trap flag 240 or taken-branch trap flag 242 that causes the processor to stop executing instructions at appropriate times, e.g., every instruction or every branch-type instruction, respectively. Depending on the specified tasks of the tracing program, the tracing program may or may not need instruction-level information. If so, when the tracing program's single-step interrupt handler or taken-branch interrupt handler receives control, it needs a copy of the most recently executed instruction.

EI flag 244 may be used to specify that the most recently executed instruction should be copied into an appropriate register, such as executed-instruction register 234. In this example, EI flag 244 may be ignored when neither single-step trap flag 240 nor taken-branch trap flag 242 have been set. Alternatively, a copy of the executed instruction may be placed into the executed instruction register whenever single-step trap flag 240, taken-branch trap flag 242, or other interrupt-enable flag has been set without regard to an executed-instruction flag.

It should be noted that the term “most recently executed instruction” refers to an instruction associated with application-level processing; the execution of instructions within an interrupt handler would usually not be of interest to a profiling program. Hence, the described examples may have a feature in which the use of an executed-instruction register may be suspended while interrupts are being serviced.

With reference now to FIG. 3A, a block diagram depicts a taken-branch instruction buffer to be used to store executed instructions with respect to the most recent branch-type instruction. The example shown in FIG. 3A shows processor 302 that contains an interrupt control unit that is similar to the processor shown in FIG. 2D. As described above with respect to FIG. 2D, a tracing program may set a taken-branch trap flag that causes the processor to stop executing instructions at every branch-type instruction and to deliver execution control to a trap handler for the taken-branch trap.

In contrast with FIG. 2D, FIG. 3A also shows taken-branch instruction buffer 304 within the interrupt control unit for storing instructions between branch-type instructions; the buffer may be a set of dedicated registers. The processor places a copy of the most recently executed instruction (or its opcode) into the taken-branch instruction buffer. The TB flag may be used to qualify the use of the taken-branch instruction buffer; if the TB flag is not set, then the processor should not store copies of instructions within the taken-branch instruction buffer. In this example, the buffer is filled in a rotating or wrap-around manner, and start indicator 306 and end indicator 308 are used to point to the first and last entries in the buffer. As in FIG. 2D, an EI flag may be used to qualify, i.e., enable or disable, the operation of copying instructions; the taken-branch instruction buffer and the executed-instruction buffer may operate in parallel.

To prevent buffer overflow, full flag 310 is associated with the taken-branch instruction buffer. When the buffer is full, the full flag is set, and the taken-branch trap handler is called by the processor in an attempt to empty the buffer. Alternatively, a special taken-branch-buffer-full interrupt can be generated, thereby causing the processor to invoke the interrupt handler that has been registered for this interrupt, which may be the taken-branch trap handler or some other piece of code. In either case, the processor may assume that the responsible handler has emptied the buffer when it returns execution control. Hence, a return-from-interrupt (RFI) from either the responsible handler or a taken-branch trap handler allows the processor to reset the start indicator and the end indicator.

With reference now to FIG. 3B, a flowchart depicts the use of a taken-branch instruction buffer within a processor. The process shown in FIG. 3B is similar to the process shown in FIG. 2C except that the operation of a taken-branch instruction buffer has been incorporated into the flowchart shown in FIG. 3B. The process begins with the completion of the execution of an instruction (step 312), which may be signaled by a completion unit within the processor. A determination is then made as to whether the executed-instruction (EI) flag has been set (step 314). If not, then process is complete. If the flag is set, then a copy of the executed instruction or its opcode is written to a register within the processor (step 316). In this example, the executed-instruction register and the taken-branch instruction buffer operate simultaneously.

A determination is then made as to whether the taken-branch flag is set (step 318). If not, then the process is complete. If the taken-branch flag is set, then a copy of the executed instruction or its opcode is written to a taken-branch instruction buffer within the processor (step 320). A determination is then made as to whether the taken-branch instruction buffer is full (step 322). If not, then the process is complete. If the taken-branch instruction buffer is full, then the buffer full flag is set (step 324), and the processor generates a buffer-full interrupt (step 326) in an attempt to empty the buffer, after which the process is complete.

FIG. 3B shows only the operation of filling and monitoring the taken-branch instruction buffer. It is assumed that when the taken-branch trap handler is invoked after the execution of a branch instruction (not shown in FIG. 3B), the taken-branch trap handler would write the saved instructions or opcodes to a trace output buffer.

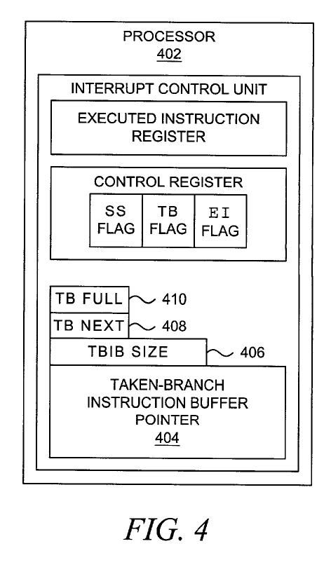

With reference now to FIG. 4, a block diagram depicts an alternative embodiment for a taken-branch instruction buffer to be used to store executed instructions. The example shown in FIG. 4 shows processor 402 that contains an interrupt control unit that is similar to the processor shown in FIG. 3A. However, it may be assumed that the size of the taken-branch instruction buffer shown in FIG. 3A is limited by the fact that the buffer is located within the processor. A relatively small taken-branch instruction buffer would be problematic for a series of instructions between branch-type instructions in which the number of instructions between those branch-type instructions was greater than the buffer size.

In contrast to FIG. 3A, processor 402 does not contain the taken-branch instruction buffer within the processor. Instead, taken-branch instruction buffer pointer 404 points to a location in memory where the taken-branch instruction buffer can be found. When appropriate, the processor writes a copy of an instruction or its opcode to the taken-branch instruction buffer. Configuration registers 406 and 408 may hold the size of the taken-branch instruction buffer and the next unused entry offset indicator, respectively. By locating the taken-branch instruction buffer in main memory, there should be adequate storage space for saving any series of instructions between branch-type instructions in application-level software.

When a taken-branch trap handler is invoked after the execution of a branch instruction, the taken-branch trap handler would write the saved instructions or opcodes from the taken-branch instruction buffer to a trace output buffer. Alternatively, the taken-branch instruction buffer may be considered to be one of a plurality of trace output buffers, and the taken-branch trap handler may merely save the taken-branch instruction buffer to persistent storage when appropriate rather than transferring its contents to another trace output buffer.

In this example, it may be assumed that the taken-branch instruction buffer is always filled from the beginning of the buffer after it is emptied or reset. In a manner similar to FIG. 3B, full flag 410 is associated with the buffer, and the full flag is set when the buffer is full, thereby causing an appropriate handler to be invoked to remedy the full condition. A return-from-interrupt may be used by the processor to reset the next unused entry offset indicator.

For the embodiment shown in FIG. 4, the write operation to store the copy of the instruction or opcode in a taken-branch instruction buffer in memory may cause unwanted interruptions, such as page faults. Hence, some preparation may be necessary to ensure that such interruptions do not occur. One methodology for preventing these interruptions is discussed in the following copending and commonly assigned application entitled “METHOD AND SYSTEM FOR INSTRUCTION TRACING WITH ENHANCED INTERRUPT AVOIDANCE”, U.S. application Ser. No. ______, Attorney Docket Number AUS920010716US1, filed on ______, currently pending, herein incorporated by reference.

As described therein, during an initialization phase, the tracing program allocates a taken-branch instruction buffer in physical memory, maps the buffer to its virtual address space, and pins the buffer. At any subsequent point in time, data accesses to the taken-branch instruction buffer would use non-virtual addressing, i.e., physical addressing instead of virtual addressing. More specifically, the physical address would be registered into the taken-branch instruction buffer pointer. By using non-virtual addressing, there is no opportunity for TLB misses, which could occur when addressing the buffer via virtual addressing. In a particular embodiment that uses the Intel® IA-64 processor architecture, the “dt” bit (data address translation bit) of the processor status register (“psr.dt”) can be used to control virtual addressing versus physical addressing. When the “psr.dt” bit is set to “1”, virtual data addresses are translated; when the “psr.dt” bit is set to “0”, data accesses use physical addressing.

In an alternative embodiment using the Intel® IA-64 processor architecture, TLB misses can be avoided by using a translation register. Translation registers are managed by software, and once an address translation is inserted into a translation register, it remains in the translation register until overwritten or purged. Translation registers are used to lock critical address translations; all memory references made to a translation register will always hit the TLB and will never cause a page fault. With respect to the present invention, a translation register could be configured for the taken-branch instruction buffer during the initialization phase of the tracing software, thereby ensuring that there are no TLB misses for the taken-branch instruction buffer.

The advantages of the present invention should be apparent in view of the detailed description of the invention that is provided above. A special mechanism is provided within the processor for revealing the most recently executed instruction; after the instruction is completed, the opcode of the instruction or the entire instruction is revealed in one of a variety of manners, such as by writing the opcode or instruction to a register that may be read by application-level code. The present invention eliminates various types of interrupts that may occur when attempting to read a copy of an instruction, and the present invention provides a solution that avoids causing any additional problems and that integrates well with other functionality within the processor and/or the operating system.

The methodology of the present invention can be compared with a methodology that is present in processors that are manufactured in accordance with the Intel® IA-64 architecture. The branch trace buffer in an IA-64 processor provides information about the outcome of the execution of the most recent IA-64 branch instructions. In every cycle in which a qualified IA-64 branch retires, its source bundle address and slot number are written to the branch trace buffer; the branch's target address is also recorded. Hence, a rolling subset of addresses for the most recent branch instructions is captured. In contrast, the present invention provides a methodology for automatically capturing copies of all instructions or their opcodes via functionality within the processor.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as microcode, nanocode, EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing an instruction within a processor, the method comprising:
executing an instruction within the processor; and
in response to completion of the executed instruction, automatically writing by the processor a copy of the executed instruction or an opcode of the executed instruction to a register within the processor.

2. The method of claim 1 wherein the register is a dedicated-purpose register that is used to hold executed instructions.

3. The method of claim 1 further comprising:
determining whether or not an enable flag was previously set prior to writing the executed instruction or its opcode to a register within the processor.

4. The method of claim 1 further comprising:
determining whether or not an interrupt-enable flag is set prior to writing the executed instruction or its opcode to a register within the processor.

5. The method of claim 1 wherein the register is one of a plurality of registers that are used to hold executed instructions or their opcodes.

6. The method of claim 1 further comprising:
determining whether or not a taken-branch flag is set prior to writing the executed instruction or its opcode to a register within the processor.

7. The method of claim 1 further comprising:
reading the register by tracing software to obtain a copy of the executed instruction or its opcode; and
writing the copy of the executed instruction or its opcode to persistent storage.

8. A method for processing an instruction within a processor, the method comprising:
executing an instruction within the processor; and
in response to completion of the executed instruction, automatically writing by the processor a copy of the executed instruction or an opcode of the executed instruction to a memory buffer.

9. The method of claim 8 further comprising:
reading a register within the processor to obtain a pointer to the memory buffer.

10. The method of claim 8 further comprising:
writing a memory address for the memory buffer to a register within the processor.

11. The method of claim 8 further comprising:
determining whether or not a taken-branch flag is set prior to writing the executed instruction or its opcode to the buffer in memory.

12. The method of claim 8 further comprising:
reading the memory buffer by tracing software to obtain copies of executed instructions or their opcodes; and
writing the copies of executed instructions or their opcodes to persistent storage.

13. A processor that performs operations specified by instructions fetched from a memory, the processor comprising:
means for fetching instructions from memory;
means for executing an instruction within the processor; and
means for automatically writing by the processor a copy of the executed instruction or an opcode of the executed instruction to a register within the processor in response to completion of the executed instruction.

14. The processor of claim 13 wherein the register is a dedicated-purpose register that is used to hold executed instructions.

15. The processor of claim 13 further comprising:
means for determining whether or not an enable flag was previously set prior to writing the executed instruction or its opcode to a register within the processor.

16. The processor of claim 13 further comprising:
means for determining whether or not an interrupt-enable flag is set prior to writing the executed instruction or its opcode to a register within the processor.

17. The processor of claim 13 wherein the register is one of a plurality of registers that are used to hold executed instructions or their opcodes.

18. The processor of claim 13 further comprising:
means for determining whether or not a taken-branch flag is set prior to writing the executed instruction or its opcode to a register within the processor.

19. The processor of claim 13 further comprising:
means for reading the register by tracing software to obtain a copy of the executed instruction or its opcode; and
means for writing the copy of the executed instruction or its opcode to persistent storage.

20. A processor that performs operations specified by instructions fetched from a memory, the processor comprising:
means for fetching instructions from memory;
means for executing an instruction within the processor; and
means for automatically writing by the processor a copy of the executed instruction or an opcode of the executed instruction to a memory buffer in response to completion of the executed instruction.

21. The processor of claim 20 further comprising:
means for reading a register within the processor to obtain a pointer to the memory buffer.

22. The processor of claim 20 further comprising:
means for writing a memory address for the memory buffer to a register within the processor.

23. The processor of claim 20 further comprising:
means for determining whether or not a taken-branch flag is set prior to writing the executed instruction or its opcode to the buffer in memory.

24. The processor of claim 20 further comprising:
means for reading the memory buffer by tracing software to obtain copies of executed instructions or their opcodes; and
means for writing the copies of executed instructions or their opcodes to persistent storage.

25. A computer program product in a computer-readable medium for use in a processor, the computer program product comprising:
means for executing an instruction within the processor; and
means for automatically writing by the processor a copy of the executed instruction or an opcode of the executed instruction to a register within the processor in response to completion of the executed instruction.

26. The computer program product of claim 25 wherein the register is a dedicated-purpose register that is used to hold executed instructions.

27. The computer program product of claim 25 further comprising:
means for determining whether or not an enable flag was previously set prior to writing the executed instruction or its opcode to a register within the processor.

28. The computer program product of claim 25 further comprising:
means for determining whether or not an interrupt-enable flag is set prior to writing the executed instruction or its opcode to a register within the processor.

29. The computer program product of claim 25 wherein the register is one of a plurality of registers that are used to hold executed instructions or their opcodes.

30. The computer program product of claim 25 further comprising:
means for determining whether or not a taken-branch flag is set prior to writing the executed instruction or its opcode to a register within the processor.

31. The computer program product of claim 25 further comprising:
means for reading the register by tracing software to obtain a copy of the executed instruction or its opcode; and
means for writing the copy of the executed instruction or its opcode to persistent storage.

32. A computer program product in a computer-readable medium for use in a processor, the computer program product comprising:
means for executing an instruction within the processor; and
means for automatically writing by the processor a copy of the executed instruction or an opcode of the executed instruction to a memory buffer in response to completion of the executed instruction.

33. The computer program product of claim 32 further comprising:
means for reading a register within the processor to obtain a pointer to the memory buffer.

34. The computer program product of claim 32 further comprising:
means for writing a memory address for the memory buffer to a register within the processor.

35. The computer program product of claim 32 further comprising:
means for determining whether or not a taken-branch flag is set prior to writing the executed instruction or its opcode to the buffer in memory.

36. The computer program product of claim 32 further comprising:
means for reading the memory buffer by tracing software to obtain copies of executed instructions or their opcodes; and
means for writing the copies of executed instructions or their opcodes to persistent storage.
